(19) United States
(12) Patent Application Publication
(10) Pub. No.: US 2003/0201109 A1
(43) Pub. Date: Oct. 30, 2003

(54) ATV loader system

(76) Inventor: Romie E. Bolen, Milton-Freewater, OR (US)

Correspondence Address: Michael S. Neustel, Suite No. 4, 2534 South University Drive, Fargo, ND, 58103, US

(21) Appl. No.: 10/127,143

(22) Filed: Apr. 24, 2002

(51) Int. Cl. A01B 51/00

(52) U.S. Cl. 172/817; 172/273

(57) ABSTRACT

An ATV loader system for allowing an ATV operator to manipulate particulate material and objects. The ATV loader system includes a base attachable to a vehicle frame, a first support member and a second support member extending upwardly and forwardly from the base, a loader frame pivotally attached to the support members, and an attachment device such as a bucket attached to the distal portion of the loader frame. A plurality of actuators are connected between the support members and the loader frame for adjusting the pivotal position of the loader frame. The actuators are preferably fluidly connected to a valve assembly which receives pressurized hydraulic fluid from an electric pump that is powered from the ATV's power source.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to all terrain vehicles (ATV) and more specifically it relates to an ATV loader system for allowing an ATV operator to manipulate particulate material and objects.

All terrain vehicles (ATV) have been in use for years and are manufactured by companies such as ARCTIC CAT, POLARIS, YAMAHA and HONDA. ATV's are commonly referred to as four-wheelers as they typically have four wheels. ATV's are utilized for various applications such as utility, sport and pleasure. However, ATV's currently are unable to manipulate particulate material such as dirt, sand or gravel. Furthermore, ATV's currently are unable to manipulate objects without the usage of a trailer. Hence, there is a need for a system that is removably attachable to an ATV for allowing for the manipulating of particulate material and objects.

2. Description of the Prior Art

Loader systems for tractors have been in use for years. A conventional loader system is comprised of a relatively heavy base structure attached to the lower side portions of a tractor. A loader frame is pivotally attached to the base structure and is manipulated by a plurality of hydraulic cylinders that are fluidly connected to the tractor's existing hydraulic system.

The main problem with conventional loaders is that they are not designed to be attached to an ATV which is of considerably less size and power than a conventional tractor. Another problem is that conventional loaders require an existing hydraulic power source to provide hydraulic pressure to the hydraulic cylinders. Another problem with conventional loaders is that they are not designed to be easily removed and attached as is required for usage upon an ATV.

While these devices may be suitable for the particular purpose to which they address, they are not as suitable for allowing an ATV operator to manipulate particulate material and objects. Conventional loaders are not suitable for usage upon conventional ATV's.

In these respects, the ATV loader system according to the present invention substantially departs from the conventional concepts and designs of the prior art, and in so doing provides an apparatus primarily developed for the purpose of allowing an ATV operator to manipulate particulate material and objects.

### SUMMARY OF THE INVENTION

In view of the foregoing disadvantages inherent in the known types of loaders now present in the prior art, the present invention provides a new ATV loader system construction wherein the same can be utilized for allowing an ATV operator to manipulate particulate material and objects.

The general purpose of the present invention, which will be described subsequently in greater detail, is to provide a new ATV loader system that has many of the advantages of the loaders mentioned heretofore and many novel features that result in a new ATV loader system which is not anticipated, rendered obvious, suggested, or even implied by any of the prior art loaders, either alone or in any combination thereof.

To attain this, the present invention generally comprises a base attachable to a vehicle frame, a first support member and a second support member extending upwardly and forwardly from the base, a loader frame pivotally attached to the support members, and an attachment device such as a bucket attached to the distal portion of the loader frame. A plurality of actuators are connected between the support members and the loader frame for adjusting the pivotal position of the loader frame. The actuators are preferably fluidly connected to a valve assembly which receives pressurized hydraulic fluid from an electric pump that is powered from the ATV's power source.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide an ATV loader system that will overcome the shortcomings of the prior art devices.

A second object is to provide an ATV loader system for allowing an ATV operator to manipulate particulate material and objects.

Another object is to provide an ATV loader system that is attachable to various sizes, styles, makes and models of all terrain vehicles.

An additional object is to provide an ATV loader system that does not interfere with the normal operation of the all terrain vehicle.

A further object is to provide an ATV loader system that may be easily removed and attached to an all terrain vehicle.

Another object is to provide an ATV loader system that increases the usage and versatility of an all terrain vehicle.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a side view of the present invention attached to an all terrain vehicle (ATV).

FIG. 3 is a side view of the present invention illustrating the movement and operation of the invention.

FIG. 4 is a front view of the present invention.

FIG. 5 is a top view of the present invention.

FIG. 6 is a block diagram illustrating the control unit in communicating with the valve assembly and pump.

FIG. 7 is a block diagram illustrating the fluid connection of the pump, valve assembly and hydraulic actuators.

### DESCRIPTION OF THE PREFERRED EMBODIMENT

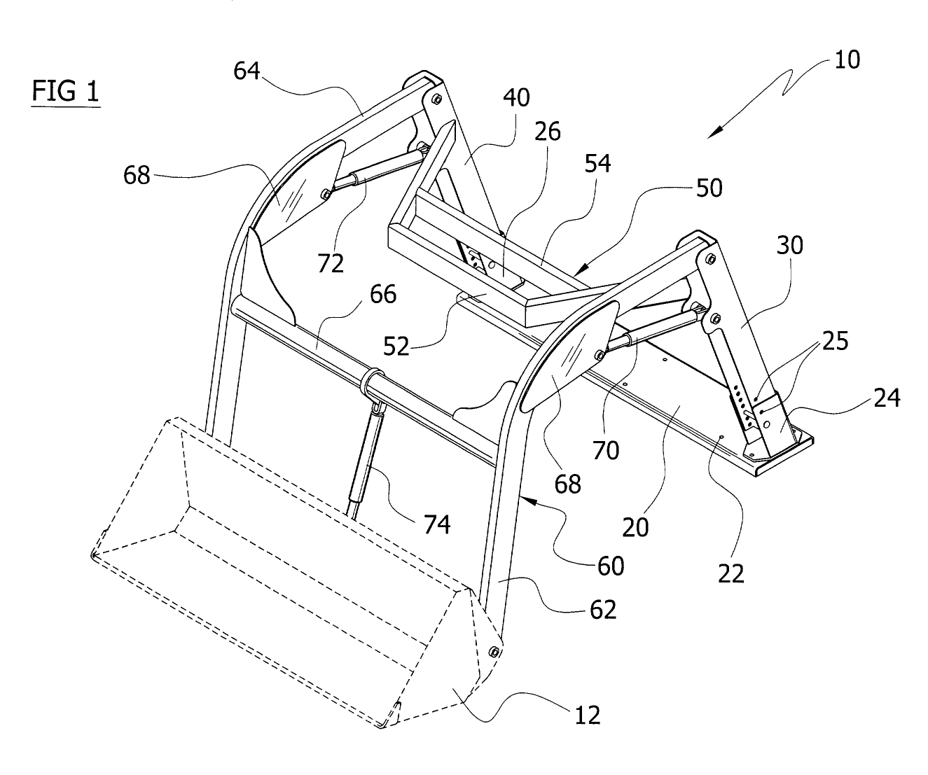

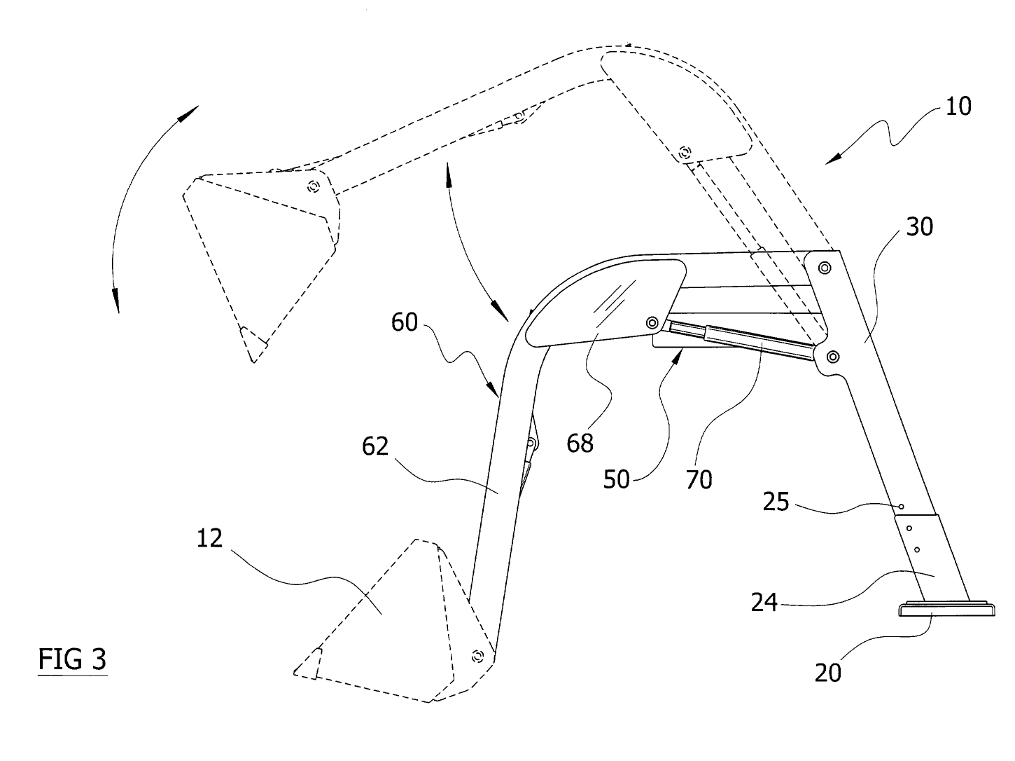

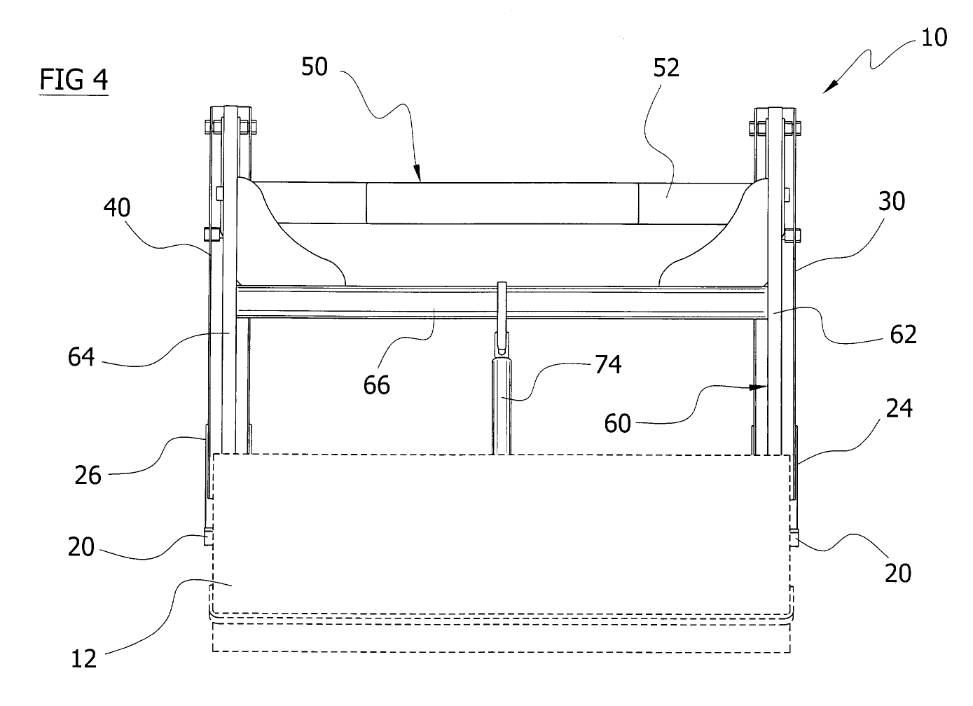

Turning now descriptively to the drawings, in which similar reference characters denote similar elements throughout the several views, FIGS. 1 through 7 illustrate an ATV loader system 10, which comprises a base 20 attachable to a vehicle frame 16, a first support member 30 and a second support member 40 extending upwardly and forwardly from the base 20, a loader frame 60 pivotally attached to the support members, and an attachment device such as a bucket 12 attached to the distal portion of the loader frame 60. A plurality of actuators are connected between the support members and the loader frame 60 for adjusting the pivotal position of the loader frame 60. The actuators are preferably fluidly connected to a valve assembly 84 which receives pressurized hydraulic fluid from an electric pump 82 that is powered from the all terrain vehicle's power source 15.

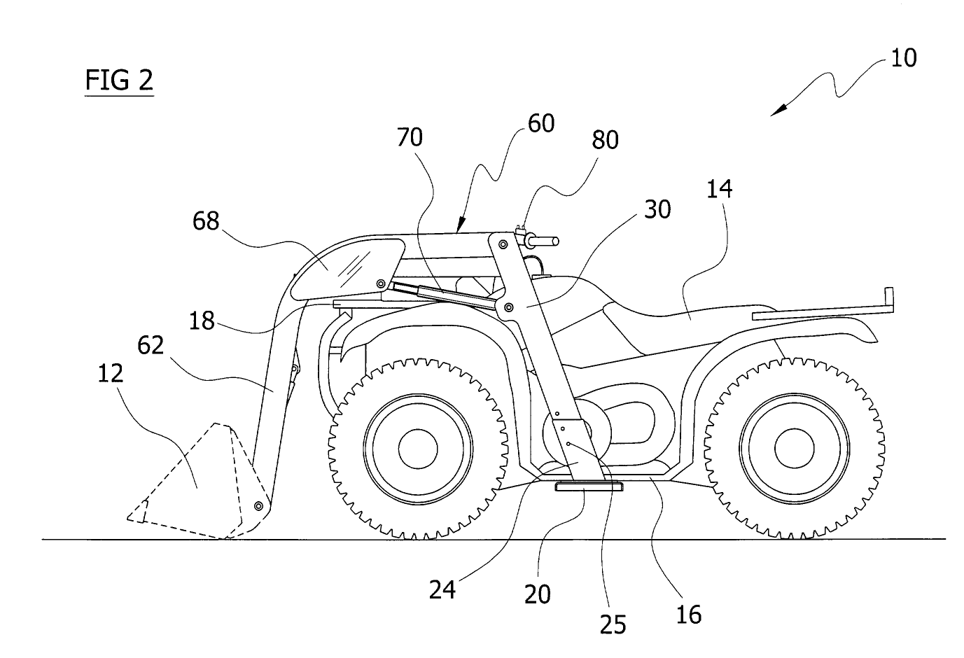

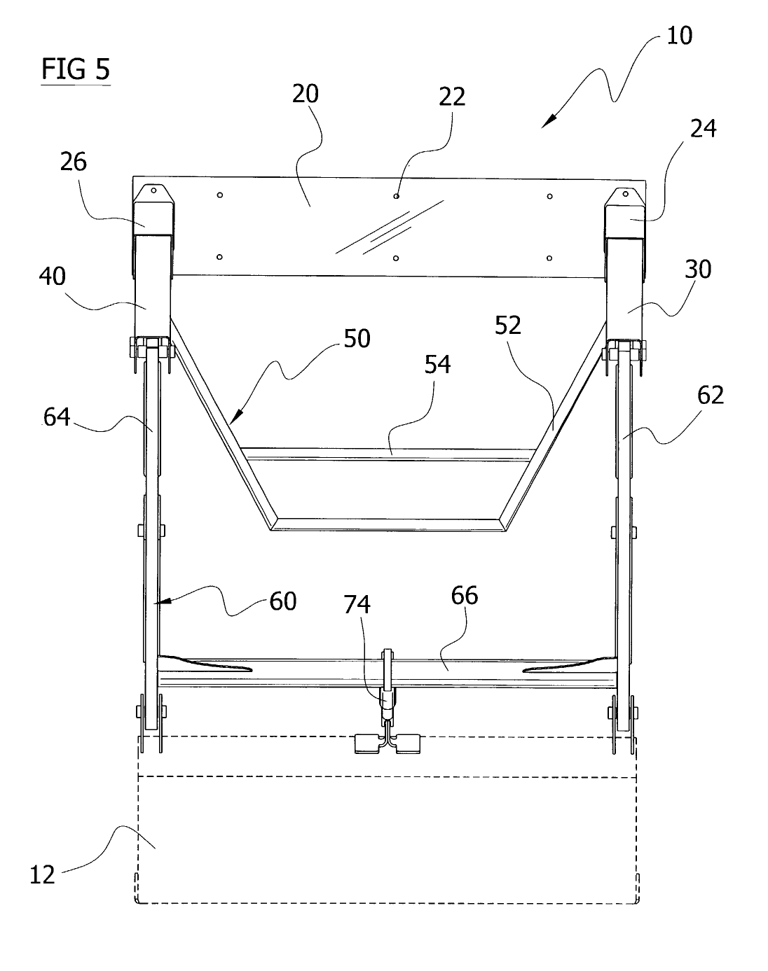

As shown in FIGS. 1 and 5 of the drawings, the base 20 is generally comprised of a flat and straight structure that is attached to the lower portion of the vehicle frame 16 of the ATV 14 (all terrain vehicle). The base 20 may have various other shapes, sizes and configurations other than that illustrated within the figures. The base 20 preferably includes a plurality of first apertures 22 for allowing conventional fasteners to secure the base 20 to the lower portion of the vehicle frame 16. As shown in FIG. 2 of the drawings, the base 20 extends from the left side to the right side of the vehicle frame 16 outwardly a finite distance. The base 20 may be attached directly to the vehicle frame 16 or indirectly such as to the footboards. It can also be appreciated that the base 20 may be permanently attached to the vehicle frame 16 utilizing welding or other attachment means.

As shown in FIGS. 1 and 5 of the drawings, a first bracket 24 is attached to a first end of the base 20. A second bracket 26 is attached to a second end of the base 20 opposite of the first bracket 24 as further shown in FIGS. 1 and 5 of the drawings. The brackets 24, 26 are formed for adjustably receiving the support members 30, 40 thereby allowing the present invention to be utilized upon differing sizes of all terrain vehicles. The brackets 24, 26 each include a plurality of second apertures 25 that are aligned with second apertures 25 within the support members 30, 40 for receiving a pin, fastener or like device for maintaining the desired position. As best shown in FIG. 1 of the drawings, the brackets 24, 26 have a U-shaped cross section for surrounding and snugly receiving the lower portion of the support members 30, 40 respectively. It can be appreciated that the support members 30, 40 may be directly attached to the base 20 without the usage of the brackets 24, 26. It can also be appreciated that the support members 30, 40 may be attached directly and permanently to the base 20.

As shown in FIGS. 1, 4 and 5 of the drawings, a first support member 30 is removably attached to the first bracket 24. As further shown in FIGS. 1, 4 and 5 of the drawings, a second support member 40 is removably attached to the second bracket 26. The support members 30, 40 extend upwardly and forwardly from the base 20 as best illustrated in FIG. 2 of the drawings. The upper portion of the support members 30, 40 is preferably behind a center axis between the front wheels of the ATV 14 as shown in FIG. 2 of the drawings. In addition, the upper portion of the support members 30, 40 is preferably positioned a finite distance away from the protective front fender of the ATV 14 to avoid interference with the same during usage of the present invention.

The support members 30, 40 may be comprised of various structures and shapes, however the lower portion of the support members 30, 40 is preferably formed to snugly fit within the interior portion of the brackets 24, 26 respectively. It can be appreciated that the support members 30, 40 may be formed to fit about the exterior portion of the brackets 24, 26 though not illustrated within the drawings.

As shown in FIGS. 1 and 5 of the drawings, an upper support frame 50 is attached between the upper portions of the support members 30, 40 to provide support for the same. The upper support frame 50 is attached to the front rack 18 of the ATV 14 with conventional fasteners. It can be appreciated that the upper support frame 50 may be attached directly to the vehicle frame 16 or similar location instead of the front rack 18.

The upper support frame 50 has a first member 52 extending between the support members 30, 40 and a second member 54 extending within the first member 52 as best shown in FIG. 5 of the drawings. The first member 52 has a tapered U-shaped structure for fitting about the steering section of the ATV 14. The second member 54 extends within the U-shaped structure so as to provide increased strength to the first member 52.

As shown in FIG. 1 of the drawings, a loader frame 60 is pivotally attached to the upper portions of the support members 30, 40. The loader frame 60 is preferably comprised of a first arm 62 and a second arm 64 pivotally attached to the first support member 30 and the second support member 40 respectively. The arms 62, 64 preferably each have a first portion and a second portion that are at an angle with respect to one another as best shown in FIG. 1 of the drawings. A pair of braces 68 are attached between the first portion and the second portion of the arms 62, 64 as further shown in FIG. 1 of the drawings. The braces 68 extend downwardly a finite distance for receiving a distal end of the actuators 70, 72. As shown in FIGS. 1, 4 and 5 of the drawings, at least one cross member 66 extends between the arms 62, 64 for providing additional support for the loader frame 60. The distal portion of the loader frame 60 is attachable to various implements such as a bucket 12 or similar device. The implement may be movably or non-movably attached to the loader frame 60 using conventional attachment devices that are well known with conventional loaders for tractors.

As shown in FIG. 1 of the drawings, a first actuator 70 is attached between the first support member 30 and the first arm 62 of the loader frame 60. A second actuator 72 is attached between the second support member 40 and the second arm 64 of the loader frame 60 as further shown in FIG. 1 of the drawings. The first actuator 70 and the second actuator 72 facilitate movement of the loader frame 60 with respect to the support members 30, 40. A third actuator 74 may be attached between the cross member 66 of the loader frame 60 and the bucket 12 or similarly attached device. The actuators 70, 72, 74 are preferably comprised of a hydraulic cylinder structure, however various other types of actuator devices such as electrical may be utilized.

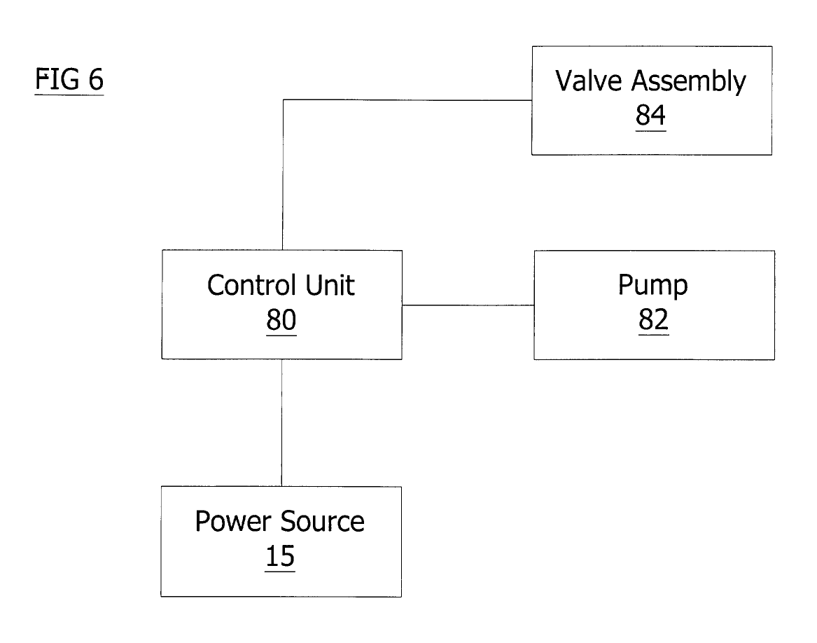

As shown in FIG. 6 of the drawings, a control unit 80 is in communication with a hydraulic pump 82 and a valve assembly 84 for controlling the operation of the same. The control unit 80 is electrically connected to a power source 15 such as but not limited to the electrical power supply of the ATV 14. The control unit 80 is comprised of a plurality of controls that allow for the control of electrical power to the pump 82 and the valve assembly 84. The pump 82 is preferably comprised of an electric motorized pump system that may operate continuously or during periods of required usage to provide hydraulic pressure to the valve assembly 84.

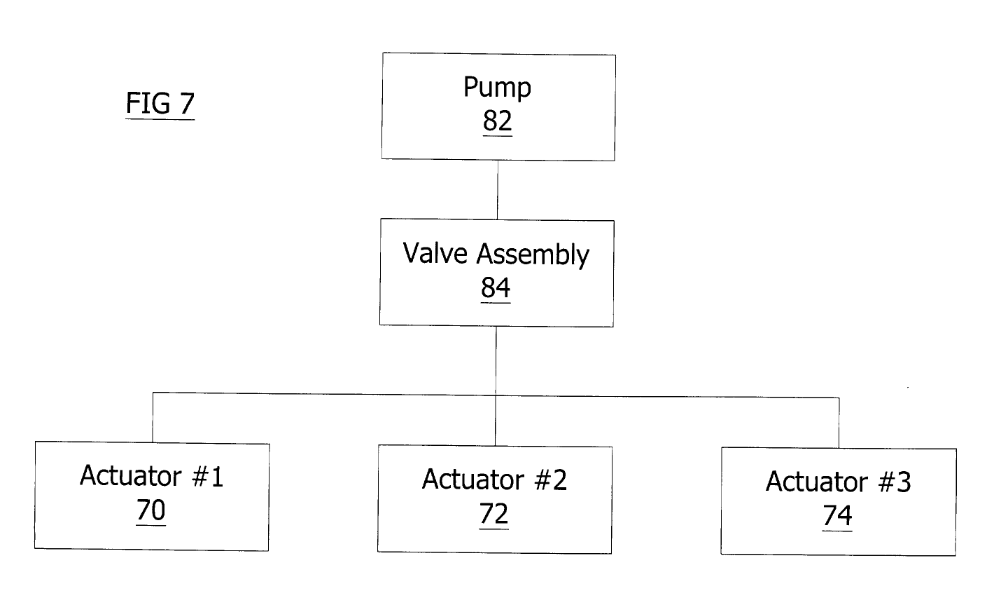

The valve assembly 84 is comprised of a conventional valve block or similar structure that utilizes solenoids to open and close hydraulic valves within the valve block. The valve assembly 84 may have a plurality of control handles to allow for the control of the valves instead of utilizing an electrical control unit. The valve assembly 84 is fluidly connected to the pump 82 as shown in FIG. 7 of the drawings. The pump 82 is fluidly connected to a hydraulic fluid reservoir (not shown) for providing pressurized hydraulic fluid to the valve assembly 84. The valve assembly 84 directs the pressurized hydraulic fluid to the appropriate actuator 70, 72, 74 as determined by the control unit 80. It can be appreciated that the first actuator 70 and the second actuator 72 receive the same flow of hydraulic fluid to allow for an evenly distributed lifting force upon the loader frame 60 and support members 30, 40.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Index of Elements for ATV Loader System

| | |
|---|---|
| □ | ENVIRONMENTAL ELEMENTS |
| □ | |
| □ | |
| □ | |
| □ | |
| □ | |
| □ | |
| □ | |
| □ | |
| □ | |
| □ | 10. ATV Loader System |
| □ | 11. |
| □ | 12. Bucket |
| □ | 13. |
| □ | 14. ATV (All Terrain Vehicle) |
| □ | 15. Power Source |
| □ | 16. Vehicle Frame |
| □ | 17. |
| □ | 18. Front Rack |
| □ | 19. |
| □ | 20. Base |
| □ | 21. |
| □ | 22. First Apertures |
| □ | 23. |
| □ | 24. First Bracket |
| □ | 25. Second Apertures |
| □ | 26. Second Bracket |
| □ | 27. |
| □ | 28. |
| □ | 29. |
| □ | 30. First Support Member |
| □ | 31. |
| □ | 32. |
| □ | 33. |
| □ | 34. |
| □ | 35. |
| □ | 36. |
| □ | 37. |
| □ | 38. |
| □ | 39. |
| □ | |
| □ | |
| □ | |
| □ | |
| □ | |
| □ | |
| □ | 40. Second Support Member |
| □ | 41. |
| □ | 42. |
| □ | 43. |
| □ | 44. |
| □ | 45. |
| □ | 46. |
| □ | 47. |
| □ | 48. |
| □ | 49. |
| □ | 50. Upper Support Frame |
| □ | 51. |
| □ | 52. First Member |
| □ | 53. |
| □ | 54. Second Member |
| □ | 55. |
| □ | 56. |
| □ | 57. |
| □ | 58. |
| □ | 59. |
| □ | 60. Loader Frame |
| □ | 61. |
| □ | 62. First Arm |
| □ | 63. |
| □ | 64. Second Arm |
| □ | 65. |
| □ | 66. Cross Member |
| □ | 67. |
| □ | 68. Braces |
| □ | 69. |
| □ | 70. First Actuator |
| □ | 71. |
| □ | 72. Second Actuator |
| □ | 73. |
| □ | 74. Third Actuator |
| □ | 75. |
| □ | 76. |
| □ | 77. |
| □ | 78. |
| □ | 79. |
| □ | |
| □ | 80. Control Unit |
| □ | 81. |
| □ | 82. Pump |
| □ | 83. |
| □ | 84. Valve Assembly |

I claim:

1. An ATV loader system for an all terrain vehicle (ATV), comprising:
a base attached to a lower portion of an ATV, wherein said base has a first end and a second end;
a first support member attached to said first end of said base extending upwardly and forwardly with respect to said ATV;
a second support member attached to said second end of said base extending upwardly and forwardly with respect to said ATV;
an upper support frame attached between upper portions of said support members, wherein said upper support frame is attached to an upper front portion of said ATV;
a loader frame pivotally attached to said support members, wherein said loader frame is adapted to receive an implement device;
a first actuator connected between said first support member and said loader frame;
a second actuator connected between said second support member and said loader frame; and
a control system in communication with and controlling said actuators for manipulating a pivotal position of said loader frame with respect to said support members:

2. The ATV loader system of claim 1, wherein said control system is comprised of:
a control unit connected to a power source;
a valve assembly in communication with said control unit, wherein said valve assembly is in fluid communication with said actuators; and
a pump electrically connected to said control unit and fluidly connected to said valve assembly.

3. The ATV loader system of claim 2, wherein said actuators are comprised of hydraulic cylinders.

4. The ATV loader system of claim 1, wherein said loader frame is comprised of:
a first arm pivotally attached to said first support member;
a second arm pivotally attached to said second support member; and
at least one cross member secured between said arms.

5. The ATV loader system of claim 4, wherein said arms of said loader frame have a first portion and a second portion extending at an angle with respect to one another.

6. The ATV loader system of claim 5, including a pair of braces attached between said first portion and said second portion of said arms.

7. The ATV loader system of claim 6, wherein said actuators are attached to said pair of braces.

8. The ATV loader system of claim 1, wherein said base is comprised of an elongate flat structure having a plurality of securing apertures for receiving securing fasteners.

9. The ATV loader system of claim 1, wherein said base is attached to opposing footboards of said ATV.

10. The ATV loader system of claim 1, wherein said upper support frame is comprised of a first member having a U-shaped structure, and a second member attached between opposing portions of said first member, wherein said upper support frame is attached to a front rack of said ATV.

11. An ATV loader system for an all terrain vehicle (ATV), comprising:
a base attached to a lower portion of an ATV, wherein said base has a first end and a second end;
a first bracket attached to said first end of said base;
a second bracket attached to said second end of said base;
a first support member removably attached to said first bracket extending upwardly and forwardly with respect to said ATV;
a second support member removably attached to said second bracket extending upwardly and forwardly with respect to said ATV;
an upper support frame attached between upper portions of said support members, wherein said upper support frame is attached to an upper front portion of said ATV;
a loader frame pivotally attached to said support members, wherein said loader frame is adapted to receive an implement device;
a first actuator connected between said first support member and said loader frame;
a second actuator connected between said second support member and said loader frame; and
a control system in communication with and controlling said actuators for manipulating a pivotal position of said loader frame with respect to said support members.

12. The ATV loader system of claim 11, wherein said control system is comprised of:
a control unit connected to a power source;
a valve assembly in communication with said control unit, wherein said valve assembly is in fluid communication with said actuators; and
a pump electrically connected to said control unit and fluidly connected to said valve assembly.

13. The ATV loader system of claim 12, wherein said actuators are comprised of hydraulic cylinders.

14. The ATV loader system of claim 11, wherein said loader frame is comprised of:
a first arm pivotally attached to said first support member;
a second arm pivotally attached to said second support member; and
at least one cross member secured between said arms.

15. The ATV loader system of claim 14, wherein said arms of said loader frame have a first portion and a second portion extending at an angle with respect to one another.

16. The ATV loader system of claim 15, including a pair of braces attached between said first portion and said second portion of said arms.

17. The ATV loader system of claim 16, wherein said actuators are attached to said pair of braces.

18. The ATV loader system of claim 11, wherein said base is comprised of an elongate flat structure having a plurality of securing apertures for receiving securing fasteners.

19. The ATV loader system of claim 11, wherein said brackets have a U-shaped cross section that snugly receive said support members within an interior portion thereof, and wherein a plurality of fasteners extend through corresponding apertures within said brackets and said support members.

20. The ATV loader system of claim 11, wherein said upper support frame is comprised of a first member having a U-shaped structure, and a second member attached between opposing portions of said first member, wherein said upper support frame is attached to a front rack of said ATV.
